(19) United States
(12) Patent Application Publication
(10) Pub. No.: US 2010/0193585 A1
(43) Pub. Date: Aug. 5, 2010

(54) Proximity Card Self-Service PIN Unblocking when used as a Primary Authentication Token to Stand-Alone or Network-Based Computer Systems

(76) Inventors: Greg Salyards, Austin, TX (US); Shaun Cuttill, Austin, TX (US)

Correspondence Address: Greg Salyards, Suite 402, 930 South Bell Boulevard, Cedar Park, TX, 78613, US

(21) Appl. No.: 12/365,761

(22) Filed: Feb. 4, 2009

(51) Int. Cl. G06K 5/00

(52) U.S. Cl. 235/380

(57) ABSTRACT

A method or a process for unblocking a second factor of authentication, utilizing self-service processes, when required for use with a Proximity Card defined by ISO 14443 and ISO 15693 standards for PC or network-based authentication, such as when a user's selected Personal Identification Number (PIN) becomes blocked due to excessive invalid attempts.

### BACKGROUND OF INVENTION

1. Technical Field

The system and apparatus described in this disclosure pertains to network communications and unblocking a second factor authentication when required with the use of a proximity card, utilizing a self-service method.

2. Related Technology

Second factor authentication has been achieved in the past by the reissuing of proximity cards, a user selected pin and intervention or interaction with security or information technology administrative personnel.

User names and password initially served as a valid means for protecting digital information: however, due to the growth of computer processing power, social networking, personnel complacency with security policy and other threats, organizations were forced to strengthen standard user names and passwords to such an extent that they have now become unusable, expensive to maintain, and in many cases the desired effect of increased security was not achieved.

As an alternative to user names and passwords, organizations have started to adopt stronger forms of authentication, known as two-factor, three-factor and four-factor authentication, such as contact based smart cards, biometric devices, Knowledge-Based Authentication, identity validation services and One-Time Password tokens.

These newer authentication methods are grouped in to various “factors” of authentication. Whereby physical nonhuman devices are referred to as “something you have”, human biometrics are referred to as “something you are”, human memory is referred to as “something you know” and personal validation of public records or third-party verification services and the alike are known as “something somebody else knows about you”.

One of the most pervasive types of physical authentication tokens is a credit card-size card used as an employee badge, commonly referred to as a proximity card that may contain a number of various embedded technologies. These badges are seen as very universal due to the requirement of many organizations to possess an organizationally issued badge to verify the physical identity of the person in possession of the badge.

In many cases these badges are multi-purpose badges used for physical identification as well as physical access to facilities. The badges are embedded with Proximity technology that enable the user to present the physical card to a physical card reader attached to a door, gate or other access point. The reader detects the identification number specific to the card, associates the identification number with a specific user and makes a decision regarding the user's ability to gain access to the requested point of access. These devices are predominantly used for physical access.

In recent years organizations have begun to adopt technology known as contact smart card technology. Contact card technology is different from proximity-based technology in that the card must make physical contact with a contact card reader. The contact smart card contains a number of secure technologies, which makes it more secure than today's proximity or contact less technologies.

The contact smart card can also perform cryptographic operations and secure content that is only resident on the integrated circuit chip protected by the contact smart card architecture. Contact smart cards gained adoption due to their ability to create and store digital certificates used for logical access to computer systems, digital signatures, encryption and a myriad of other valuable features.

The Achilles Heal of the contact smart card is its increased cost, costing as much as three to four times as a proximity or contact less card per unit and the requirement for organizations to issue new badges to all employees within their organization, which is viewed as a huge upfront cost and a loss of valuable productivity. Another major factor in the usability of a contact smart card is the user's requirement to be in possession of the contact smart card at all times when access is required to computer systems.

While organizations realize they must increase security surrounding logical access to computer systems, they also realize that personnel must be able to continue to work in order to keep their personnel productive. An employee who has lost their card or who has blocked the PIN used in concert with the card could become non-productive for hours until a new card is issues to the user, the PIN is unblocked, or in the worst case—a password is created for short-term use. These challenges with cost and usability have scared organizations and slowed the broader adoption of two-factor card-based solution.

This invention attempts to address both cost and usability challenges faces by organizations large and small while maintaining a suitable level of security. The use of proximity and contact less cards for physical access is pervasive, with an estimated billion plus cards in circulation today.

These cards are already purchased, printed, deployed and in use by personnel around the world. In many cases personnel are in possession of multiple proximity or contact less cards. This invention embraces the use of these cards as opposed to attempting to force organizations to procure new, more expense contact cards and suffer the added expense of printing, deploying and lost personnel productivity.

More importantly, this invention attempts to resolve one of the stated aspects of the second and in many cases more important issue of usability. Users must be able to unblock their PIN in the event their PIN becomes blocked and organizations should be able to make the decision to permit their personnel to do so without intervention or interaction with security or information technology administrative personnel—this process is known as self-service.

### SUMMARY OF INVENTION

A method or a process for unblocking a second factor of authentication, utilizing self-service processes, when required for use with a Proximity Card defined by ISO 14443 and ISO 15693 standards for PC or network-based authentication, such as when a user's selected Personal Identification Number (PIN) becomes blocked due to excessive invalid attempts.

### SUMMARY OF DRAWINGS

The features of the invention are believed to be novel and the elements characteristic of the invention are set forth with particularity in the appended claims. The figures are for illustration purposes only and are not drawn to scale. The invention itself however, both as to organization and method of operation, may best be understood by reference to the detailed description which follows taken in conjunction with the accompanying drawings in which:

FIG. 1 illustrates the required components of the user's successful logon.

FIG. 2 illustrates components of failed logon due to lack of a valid card.

FIG. 3 illustrates components of failed logon due to lack of a valid PIN.

FIG. 4 illustrates components of blocked PIN due to the user entering an invalid PIN a number of times in excess of allowed attempts

FIG. 5 illustrates components of failed Knowledge Based Authentication validation.

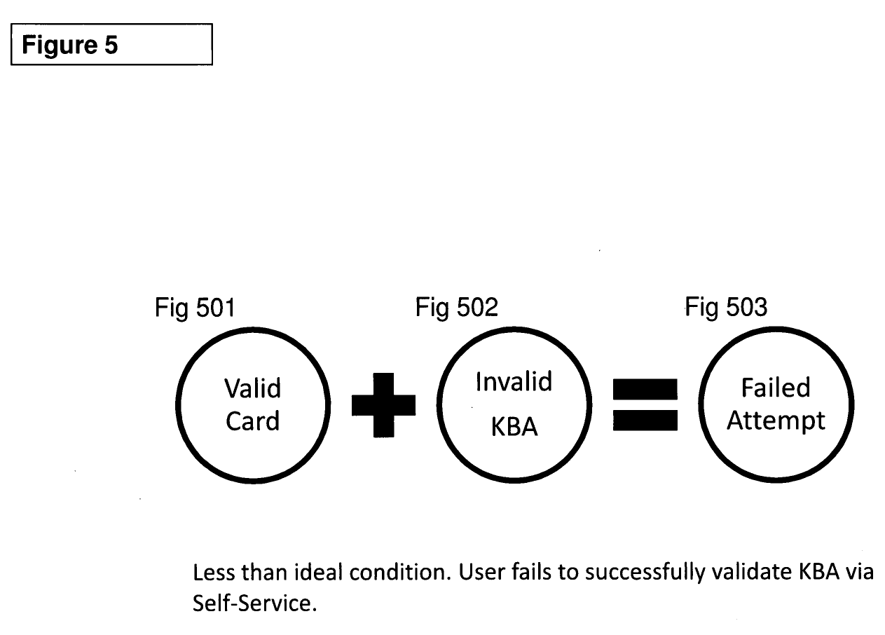

FIG. 6 illustrates components of blocked Knowledge Based Authentication validation due to invalid Knowledge Based Authentication a number of times in excess of allowed attempts.

FIG. 7 illustrates components of successful PIN unblock due to successful Knowledge Based Authentication.

FIG. 8 illustrates components of user's successful logon after the user's PIN is unblocked.

### DETAILED DESCRIPTION OF INVENTION

Proximity card self-service PIN unblocking is for determining whether a person (hereinafter “user”) is authorized to have access to a stand-alone or network-based computer system once the user's PIN has been blocked due to an excess of invalid PIN entry. The PIN is a personal identification number established by the users and known by the system and the system is a software application that collects, stores and validates information.

Evidence of this authority may be in the form of Knowledge Based Authentication (hereinafter “KBA”) as a fallback to the user's forgotten PIN. KBA, in combination with a valid Proximity card authenticates the identity and authorization of the user. As does a PIN, KBA fits into the category of “something the user knows” and is a viable alternative to a user selected PIN.

In this process, KBA is a set of known system questions from which during enrollment the user is required to select a subset of the known system questions and then provide answers to the subset of selected questions.

These answers are then stored by the system and used by the user in the event the user fails to successfully validate the PIN. KBA is used to validate the user in lieu of the PIN. Once validated the system will require the user to select a new PIN to be used in conjunction with the valid Proximity card to access the system.

During enrollment the user is required to create an individual account. Enrollment requires the user to provide their primary username and password to the application. The application stores the username and encrypts the password for future use.

The next step in the enrollment process requires the user to select a PIN for use with their Proximity card. The Proximity Card is a known card that is paired with an existing authorized user and the user's account user name, account password, and account domain.

The user selects a PIN based upon administrator defined PIN policy. Once set, the user presents the Proximity card to a proximity card reader. The reader reads the card data specific to the card and stores the data in the user's account. The application then generates a security token that is stored in the users account and may also be stored on the Proximity card, if the Proximity card is capable of storing data.

The user is then presented with a list of questions from which the user is required to select a certain number that was previously defined by the administrator. Once selected the user must provide answers to the selected questions. Once answered the answers are stored securely within the user's account for future validation.

The next step in the enrollment process provides the user with the capability of selecting how the card will behave when presented and removed from the reader. The user may elect to secure the primary password initially provided when the user's account was created. By doing so the user enhances the level of security within the system as the previous password is scrambled and a completed 32 to 64 character password is generated.

After this process the user no longer knows their logon password and may only authenticate to the system with their Proximity card or through Emergency Access. Once the password has been secured the enrollment process is complete.

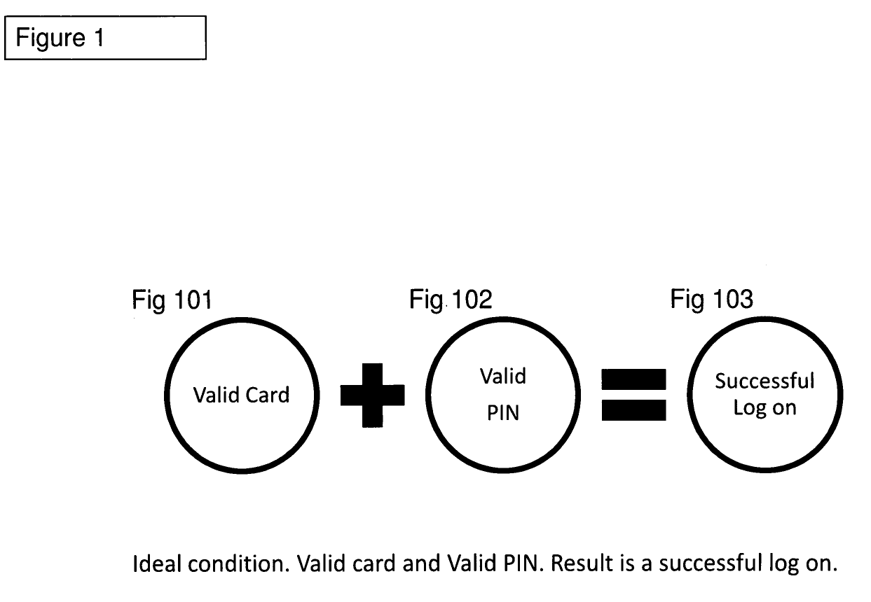

FIG. 1 illustrates when the user requires access to the system, the user presents their Proximity card (FIG. 101). The application reads the card data and may match the associated security token. Once read the application presents the user with the user account and requests the user to enter the associated PIN (FIG. 102).

The user enters the PIN and the application compares the entered PIN with the PIN previously selected by the user and stored by the application. In FIG. 1 the PIN matches and the application retrieves the user's password and provides the password to the operating system (FIG. 103).

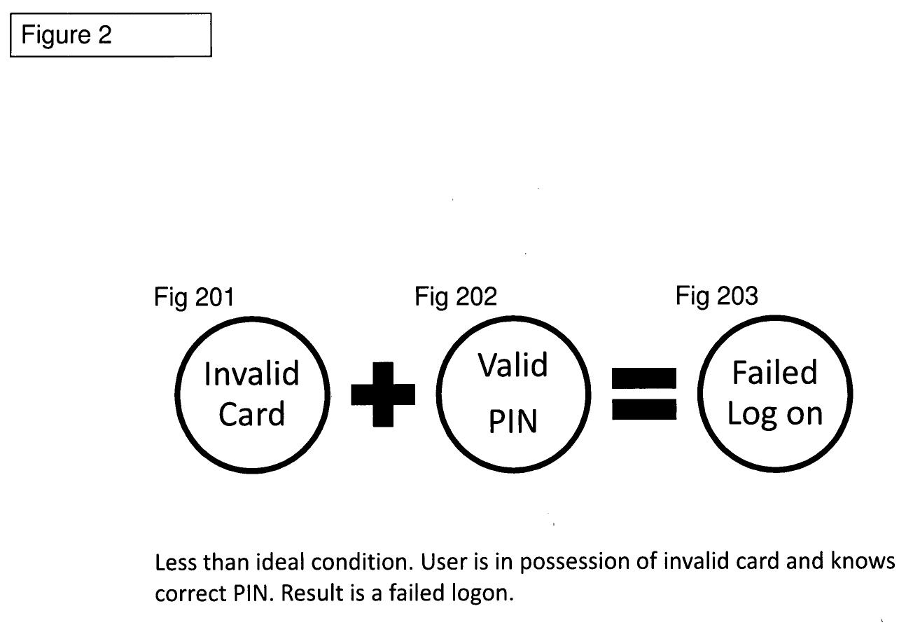

If the PIN does not match as in FIG. 2 the user has failed to logon. This may be due to an invalid card (FIG. 201) or an invalid pin (FIG. 302). In either case the user is requested to re-enter the PIN. The user must re-enter the PIN and the validation process begins anew. If the PIN does not match again the process begins anew. An administrator configures the number of attempts the user is permitted, before the PIN is blocked. By default the user may only attempt three times.

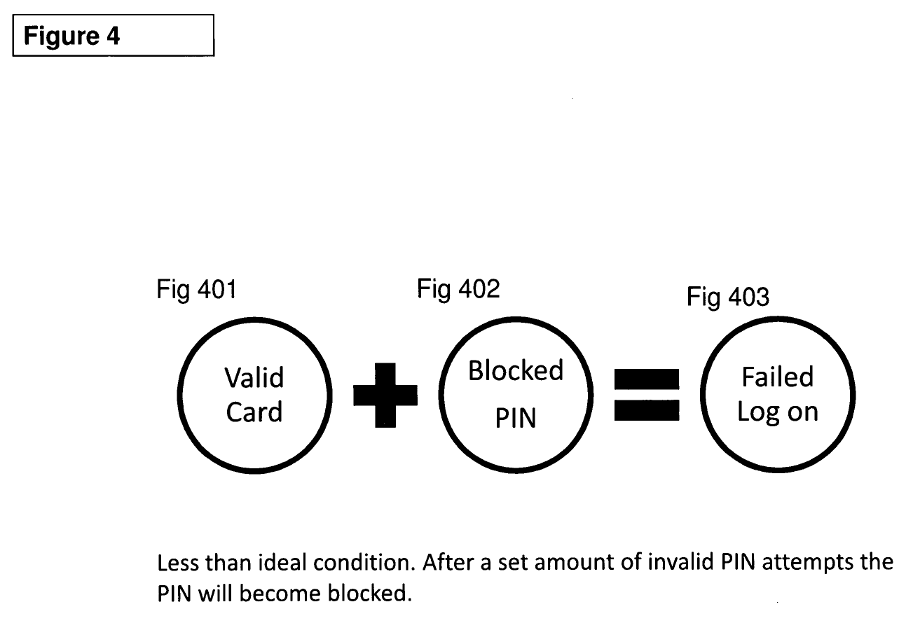

In FIG. 4 the maximum number of attempts has been reached unsuccessfully and the user is informed that the PIN is blocked (FIG. 402). During this process the user's account is flagged as being blocked and further attempts to access the account will be unsuccessful even if the correct PIN is entered. The PIN must be unblocked before the user may access the system utilizing the Proximity card.

When the PIN is blocked the user is unable to access the system with their assigned Proximity card and associated PIN. However, the user is still in possession of their Proximity card, thereby satisfying the “something the user has” requirement, but the second factor “something the user knows” has yet to be validated.

The user must then select Emergency Access from the logon interface. Once selected the user will be presented with a screen in which the user provides their user name and log-on domain. Once provided, the application will retrieve the questions selected by the user during enrollment.

The user may be presented with the entire list of questions or a subset thereof. By default the user selects from a list of 27 questions from which the user must select ten and provide answers. During Emergency Access events the user is presented with three of the ten questions.

The user must provide correct answers to each of the questions. In the event the user fails to provide the correct answers to the questions, the application will generate a new list of previously selected questions. This process will continue until the user provides the correct answers to all the provided questions or the user fails to provide the correct answers.

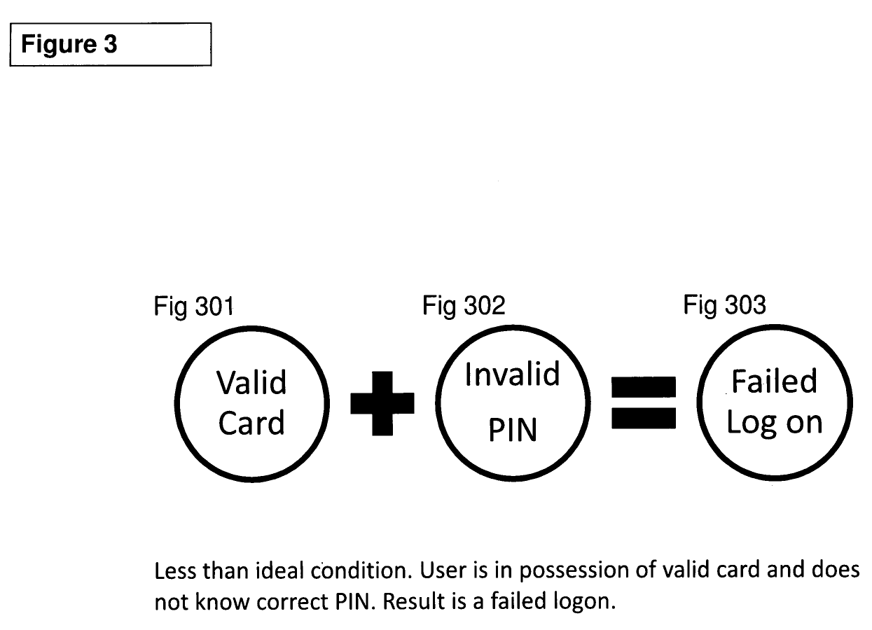

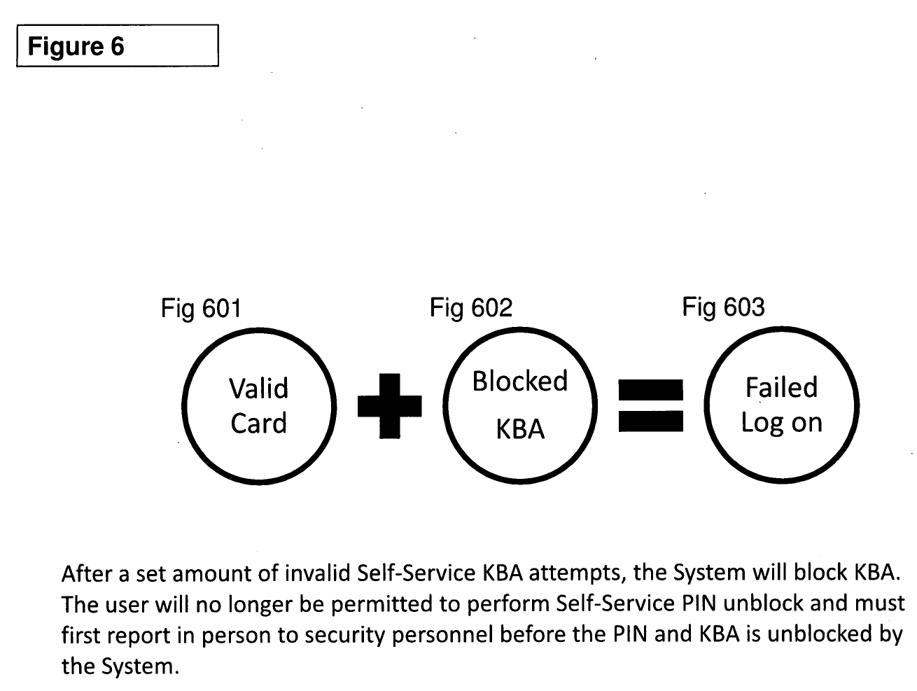

In FIG. 3, the number of incorrect attempts is previously defined by the administrator as with the PIN threshold. By default the user may attempt to provide correct answers to three sets of stored questions. In FIG. 6 the user is not able to provide the correct answers within the defined threshold and the application becomes locked (FIG. 603). In FIG. 6 only an administrator can assist the user to gain access to the system.

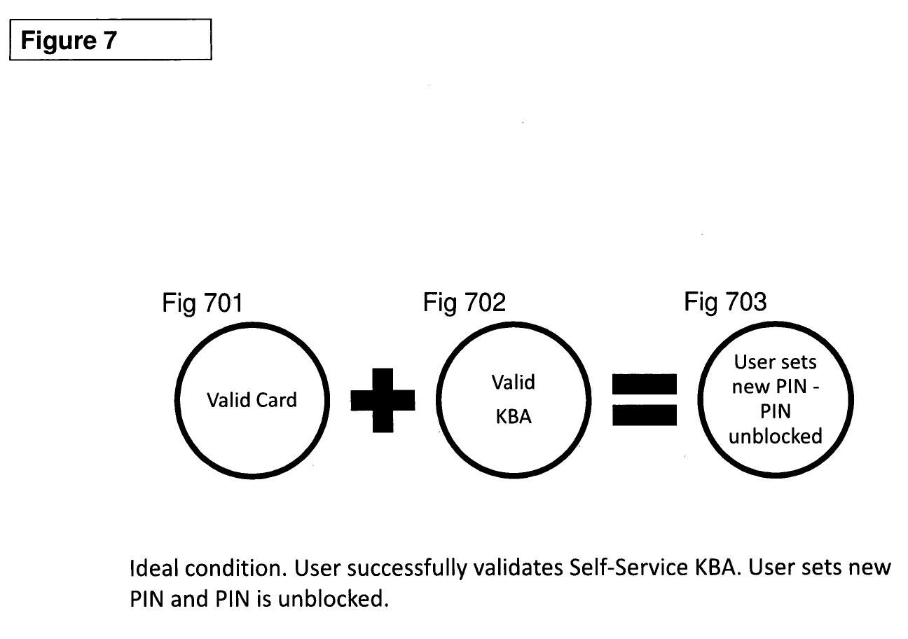

In FIG. 7 the user successfully provides answers to the questions and the application will request the user to present their Proximity card. The application will confirm the card data to validate that the card in the user's possession is in fact the card that was previously enrolled. This process validates the “something the user has” requirement of the two-factor process. The application may optionally validate the security token stored on the Proximity card.

Upon validation the application then provides the user with the ability to select a new PIN (FIG. 703). This process is very similar to the enrollment PIN selection process. The user enters their new PIN and confirms the PIN. The application then securely stores the new PIN and may generate a new security token to be secured on the Proximity card. Once complete the application resets the user's account so that the PIN is no longer blocked.

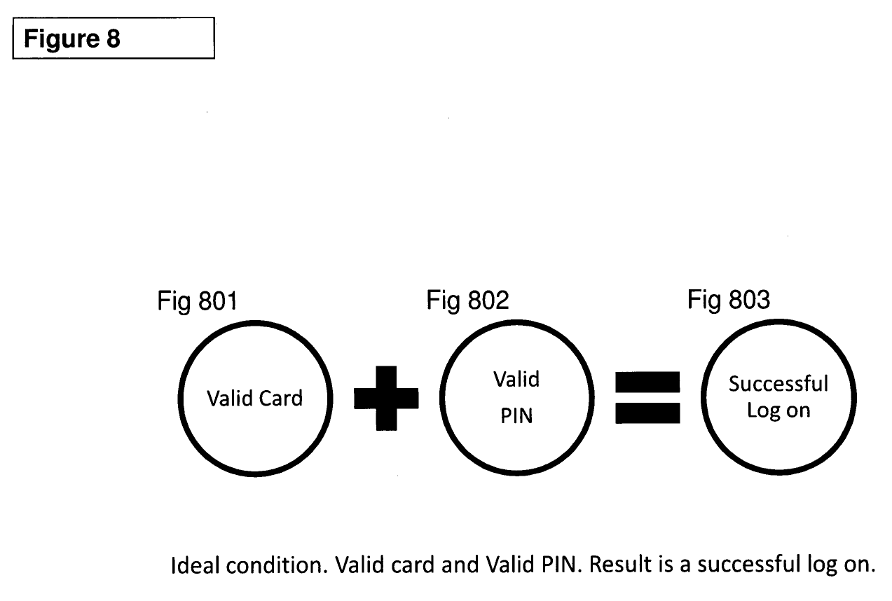

In FIG. 8 the user is then returned to the main screen from which they are able to present their Proximity card (FIG. 801). The application reads the card data and may match the associated security token. Once read the application presents the user with the user account and requests the user to enter the associated PIN. The user enters the PIN (FIG. 802) and the application compares the entered PIN with the PIN previously selected by the user and stored by the application. If the PIN matches the application retrieves the user's password and provides the password to the operating system. The user is able to gain emergency access through a self-service process that does not require the interaction of a third-party (FIG. 803).

1. A method for user authentication, the method comprising a security application that requires two-factor authentication.

2. A method for user authentication, the method comprising a security application that enables Knowledge Based Authentication of a stand-alone or network-based computer system.

3. The method of claim 1, wherein the first factor of two-factor authentication is ‘something the user has.’

4. The method of claim 1, wherein the second factor of two-factor authentication is ‘something the user knows.’

5. The method of claim 1, wherein the security application requires two-factor authentication including ‘something the user has’ in combination with ‘something the user knows.’

6. The method of claim 2, wherein the security application is for determining whether a person (hereinafter “user”) is authorized to have access to a stand-alone or network-based computer system.

7. The method of claim 2, wherein the security application requires ‘something the user has’ in combination with ‘something the user knows’ also known as the user's PIN to achieve authorization to a stand-alone or network based computer system.

8. The method of claim 2, wherein if the user blocks their PIN due to an excess of invalid PIN entries the user may use Knowledge Based Authentication to unblock their PIN.

9. The method of claim 3, wherein ‘something the user has’ includes contact-less or proximity smart cards.

10. The method of claim 4, wherein ‘something the user knows’ includes standard name and password as well as answers to questions the user selected during the enrollment process.

11. The method of claim 8, wherein the security application will contain a system setting that provides users with self-service emergency access when access has been blocked due to excessive invalid attempts.

12. The method of claim 8, wherein a PIN has been blocked the system allows the user to answer questions previously chosen by them in order to unblock their PIN therefore utilizing Knowledge Based Authorization.

13. The method of claim 12, wherein self-service access diminishes the requirement of administration in order to unblock a user from a stand-alone or network based computer.

14. A system for authenticating the authorization of a user in the event of a blocked PIN comprising:
(a) items in the users possession;
(b) information that the user is aware of;
(c) elimination of the need for administration to unblock the user.
